(19) United States
(12) Patent Application Publication
(10) Pub. No.: US 2009/0093374 A1
(43) Pub. Date: Apr. 9, 2009

(54) METHOD OF ARRAYING CELLS AT SINGLE-CELL LEVEL INSIDE MICROFLUIDIC CHANNEL AND METHOD OF ANALYSING CELLS USING THE SAME, AND CELL ANALYSIS CHIP USED FOR CARRYING OUT THE SAME

(76) Inventors: Kahp-Yang Suh, Seoul (KR); Min-Cheol Park, Hwaseong-Si Gyeonggi-Do (KR)

Correspondence Address: IPLA P.A., 3580 WILSHIRE BLVD., 17TH FLOOR, LOS ANGELES, CA, 90010, US

(21) Appl. No.: 12/299,012

(22) PCT Filed: Jan. 25, 2007
(86) PCT No.: PCT/KR07/00443

§ 371 Date: Oct. 29, 2008

(51) Int. Cl. C40B 30/06; C40B 50/18; C40B 40/02

(52) U.S. Cl. 506/10; 506/32; 506/14

(57) ABSTRACT

Provided are a method of arraying cells at a single-cell level effectively, simply and economically, a method of analyzing cells using the same, and a cell analysis chip used for carrying out the same. To this end, a microfluidic channel having well structures is formed, and a cell solution containing cells is then introduced into the fluidic channel. Thereafter, the cell solution recedes in the microfluidic channel, thus providing a method of arraying cells in the well structures at a single-cell level, a method of analyzing cells using the same, and a cell analysis chip used for carrying out the same. With only very small amount of samples, it is possible to arraying the cells at a single-cell level very simply and economically without an additional apparatus or power. Accordingly, responsiveness such as response intensity of each cell upon an analysis reagent can be observed and the analysis can be made at a single-cell level. That is, it is possible to enhance the reliability of the cell analysis notably and improve the efficiency and accuracy of an individual cell analysis remarkably, so that these methods and cell analysis chip can be widely applied to the whole bio industries.

### TECHNICAL FIELD

The present invention relates to a method of arraying cells inside a microfluidic channel, a method of analyzing cells using the same, and a cell analysis chip used for carrying out the same, and more particularly, to a method of reliably arraying cells at a single-cell level with remarkably improved efficiency and economy, a method of analyzing cells using the method, and a cell analysis chip used for carrying out the method.

### BACKGROUND ART

Recently, to overcome the limitation of an overall analysis for a cell group, there is an ongoing demand for a method of individually analyzing cells at a single level. However, it is prerequisite to array a cell group at a single-level cell efficiently and rapidly in order to efficiently observe and analyze individual characteristics of cells.

To this end, various methods for arraying and analyzing cells have been proposed.

U.S. Pat. No. 5,942,443 (Oct. 24, 1999) discloses a system which is capable of analyzing a variety of different samples using a microfluidic device including at least two intersecting channels. According to this system, however, it is impossible to analyze cells at a single-cell level.

U.S. Pat. No. 6,902,883 (Jun. 7, 2005) discloses a method of arraying cells on a pre-patterned substrate along the patterned shape thereof, and analyzing the cells. However, this method does not use a microfluidic device so that it is disadvantageous in that a lot of analysis samples are needed and it takes a relatively long time for analysis. Moreover, it is also impossible to analyze cells at a single-cell level.

This will described in detail using, for example, yeast. Yeast (Saccharomyces cerevisiae) is the first eukaryotic cell of which a nucleotide sequence of a gene is perfectly analyzed. Further, since the yeast grows rapidly, is harmless to a human being, and gene manipulation is easy, the yeast is essentially used as samples in biological research.

In such a gene-based analysis system, a green fluorescent protein (GFP) is popularly used as an analysis tool. However, in a conventional system such as a 96-well plate or 384-well plate, GFP expression in a cell group should be observed. Of course, the average GFP expression at a cell group level provides meaningful information to comprehend general characteristics of cells.

However, there is a limitation in analyzing cells at a single-cell level, and thus so-called ‘ensemble averaging problem’ is generated. Therefore, characteristics of an individual cell cannot be found out. For this reason, it is necessary to develop a new technology of economically and effectively arraying yeast at a single-cell level in a large area.

To overcome such a limitation and problem, studies are being actively conducted on methods utilizing microfluidics or lab-on-a-chip concept in recent years. The microfluidic device is advantageous in that high-speed analysis is possible in a short time using only very small amount of sample.

For example, to array cells in a microfluidic channel, a surface is patterned using polyethyleneglycol (PEG) or cells are confined using hydrogel. However, these methods have several problems that they cannot be applied to a suspended cell such as yeast, and further ultraviolet (UV) should be used to confine cells in hydrogel.

Alternatively, a hydrodynamic confinement method (“Microfluidic device for single-cell analysis”, Analytical Chemistry (2003), A. R. Wheeler, pp. 3581-3586), and a passive confinement method may be also used to array cells in a microfluidic channel. However, these methods are problematic in that it is very difficult to array a number of cells at a single-cell level in a large area.

In addition, there has been proposed a method of suggesting an optimized condition by forming a microwell array in a petridish and chasing how cells are trapped in microwell structures depending on a size and depth of the microwell structure and a precipitation time (“Large-scale single-cell trapping and imaging using microwell arrays”, Analytical Chemistry (2003), A. R. Wheeler, pp. 3581-3586). Although this suggests that the cells can be trapped in the microwell structures through the simple method, a microfluidic dynamic technology is not used so that the amount of sample to be used is considerably large. Moreover, there is a limitation in analyzing cells after arraying the cells.

Microfluidic technologies relating to flow generation and control for transferring and controlling ultra-small volume of fluid are key technologies for making it possible to drive a diagnosing and analyzing apparatus in a microfluidic device. These technologies can be realized on the basis of various driving principles. Among them, typical are a pressure-driven method for pressurizing a fluid injection portion (“Molded polyethylene glycol microstructures for capturing cells within microfluidic channels”, Lab on a Chip (2004), A. Khademhosseini, pp. 425-430), an electrophoretic method or an electroosmotic method for applying a voltage between micro channels to transfer fluid, and a capillary flow method using a capillary force.

However, since driving methods except for the capillary flow method requires an additional apparatus, complicated steps should be performed in use and it is difficult to form a device in the shape of a portable chip.

A self-assembly method has been announced (“Template-assisted self-assembly of spherical colloids into complex and controllable structures”, Advanced Functional Materials (2003), Y. Xia, pp. 907-918). In this method, a meniscus is generated between two templates, and then the two templates are inclined. Thus, the meniscus recedes, and accordingly colloid particles are self-assembled in a desired shape.

However, this method also has a problem that it is not suitable for analyzing a biomaterial with a very small amount because of using the two templates, not a fluidic channel, and also using a polystyrene bead, not a biological sample such as yeast.

Furthermore, another self-assembly method is disclosed in a paper (“Two-dimensional self-assembly of latex particles in wetting films on patterned polymer surfaces”, Journal of Physical Chemistry B (2002), Y. Sun, pp. 2217-2223). According to this method, a latex particle solution is dropped onto a patterned substrate, and a receding meniscus is then generated on the substrate as the solution is evaporated. Due to the lateral capillary force at the receding meniscus, therefore, the latex particles are self-assembled according to the shape of the substrate. However, the efficiency of this method becomes poorer when it is directly applied to yeast or animal cells because this method uses the substrate, not a microfluidic channel, and also uses the latex particle, not biological samples.

[Disclosure]

[Technical Problem]

It is an object of the present invention to provide a method of arraying cells at a single-cell level effectively, simply and economically.

It is another object of the present invention to provide a method of analyzing cells, which can effectively analyze an individual response of a cell using the method of arraying cells at a single-cell level.

It is still another object of the present invention to provide a cell analysis chip used for carrying out the method of arraying cells at a single-cell level.

[Technical Solution]

In an aspect of the present invention, there is provided a method of arraying cells at a single-cell level in a fluidic channel, including: preparing a cell analysis chip including a fluidic channel having well structures; introducing a cell solution containing cells into the fluidic channel; and manipulating the cell solution in the fluidic channel to array the cells in the well structures.

In another aspect of the present invention, there is provided a method of analyzing cells at a single-cell level, including: preparing a cell analysis chip including a fluidic channel having well structures; introducing a cell solution containing cells into the fluidic channel; manipulating the cell solution in the fluidic channel to array the cells in the well structures; introducing an analysis reagent into the fluidic channel; and analyzing a response of the cell arrayed in the well structure upon the analysis reagent.

In still another aspect of the present invention, there is provided a cell analysis chip of a single-cell level, including: a substrate; a polymer pattern layer disposed on the substrate, and including well structures for arraying cells at a single-cell level; and a polymer mold disposed on the polymer pattern layer to form a fluidic channel.

According to the present invention, since cells are arrayed using a receding meniscus and a capillary flow caused by a surface tension, it is possible to array the cells at a single-cell level very simply and economically without an additional apparatus or power. Furthermore, the present invention is applicable to a large scale using only very small amount of sample so that a large amount of cell can be rapidly and uniformly arrayed in each well structure at a single-cell level and can be used for a single cell analysis.

Therefore, the responsiveness, e.g., response intensity of each cell, not a cell group, upon an analysis reagent can be individually observed and analyzed, thus overcoming an ensemble averaging problem. That is, it is possible to observe the response at an individual cell level more accurately. In particular, the arraying method according to the present invention is advantageous in that it can be applied to an animal cell as well as a suspended cell such as yeast.

Since the analysis chip using this arraying method can be very simply constructed and used easily, this chip is portable so that an analysis place is not limited to a laboratory only and a response of an individual cell can be economically observed as well. In conclusion, the methods and the analysis chip of the present invention may be used as a platform technology widely applicable to bio industries, which can enhance the reliability of a cell analysis and improve the efficiency and accuracy of an individual cell analysis notably.

Hereinafter, a method of arraying cells at a single-cell level, a method of analyzing cells at a single-level cell using this method, and a cell analysis chip used for carrying out these methods will be described more fully with reference to the accompanying drawings.

The present invention provides a method of arraying cells at a single-level cell.

FIGS. 1 to 5 are sectional views illustrating a method of arraying cells at a single-cell level according to an embodiment of the present invention.

Referring to FIGS. 1 to 5, in the method of arraying cells at a single-level cell according to the embodiment of the present invention, a cell analysis chip 100 including a microfluidic channel 50 with well structures 22 is prepared (see FIG. 1), and thereafter a cell solution 60 containing cells 62 is introduced into the microfluidic channel (see FIG. 2). Afterwards, the cell solution 60 is manipulated in the microfluidic channel 50 so that the cells 62 are arrayed at a single-cell level in the well structures 22 (see FIGS. 3 to 5).

Each operation of the method of arraying cells at a single-cell level will be described in detail below.

According to this embodiment, the cell analysis chip 100 is prepared first. Referring to FIG. 1, the cell analysis chip 100 includes a substrate 10, a polymer pattern layer 20 with the well structures 22 disposed on the substrate 10, and a polymer mold 30 covering the polymer pattern layer 20. The fluidic channel 50 is a pathway formed between the polymer pattern layer 20 and the polymer mold 30. Specifically, the fluidic channel 50 is a pathway where the cell solution 60 can be manipulated. Here, the manipulation of cell solution 50 may include, for example, introducing the cell solution 60 into the microfluidic channel 50 by capillary flow phenomenon or making the cell solution 60 recede while evaporating the introduced cell solution 60.

In this embodiment, the capillary flow phenomenon occurs due to a surface tension when the cell solution 60 is introduced or recedes through the microfluidic channel 50. Therefore, it is preferable that the fluidic channel 60 is a microfluidic channel having a size of several tens to several hundreds of micrometers, and a height of several tens of micrometers.

A main object of this embodiment is to array target cells into the well structures individually. Hence, the well structure 22 must serve a role of confining a cell individually, i.e., a single-cell level. For this reason, the cell analysis chip 100 can be fabricated using various methods of forming patterns that can form the well structure 22 with micro-size and shape.

The method of forming the analysis chip will be exemplarily illustrated according to a preferred embodiment below. However, it is noted that the method of forming the analysis chip is not limited to following description.

FIGS. 6A to 6D are sectional views illustrating a method of forming a cell analysis chip including a fluidic channel in FIG. 1.

Referring to FIGS. 6A and 6B, the polymer pattern layer 20 having the well structures 22 is formed on the substrate 10 through a capillary lithography. For example, a pre-polymer, e.g., polydimethylsiloxane (PDMS), and a curing agent are mixed at a ratio of approximately 10:1, and then the mixture is poured onto an intagliated silicon wafer that is prepared through photolithography. Thereafter, the wafer with the mixture is cured at approximately 70° C. for approximately 1 hour in an oven, and the silicon waver is then removed, thereby forming a PDMS embossed stamp 1.

Afterwards, the well structures 22 can be formed by the use of, for example, a capillary lithography. In detail, a few of polymer droplets are dropped onto the substrate 10 to form a polymer layer 2, and the PDMS embossed stamp 1 is then positioned on the polymer layer 2. The substrate 10 may include a glass substrate, and the polymer layer may be formed of, for example, polyurethaneacrylate (PUA).

Next, referring to FIG. 6B, polymer of the polymer layer 2 is filled into a vacant space of the polymer embossed stamp 1 by a capillary flow. For facilitating the capillary flow, the embossed patterns of the polymer embossed stamp 1 should be densely formed. After that, the polymer is cured using ultraviolet (UV) rays, and then the polymer embossed stamp 1 is removed, thereby forming an intagliated pattern, i.e., the polymer pattern layer 20 with the well structure 22, on the substrate 10.

The well structures 22 formed by the capillary lithography have such advantageous characteristics that they are robust and their shapes are uniform. It is preferable that the shape, size and depth of the well structure 22 should be adjusted depending on the number and kin of cells to be arrayed.

Thereafter, a polymer mold 30 is prepared, which will be bonded to the polymer pattern layer 20 to form the microfluidic channel 50 therebetween, The polymer mold 30 may be formed of PDMS. It is preferable that the polymer mold 30 includes an inlet 32 for introducing the cell solution 60 into the fluidic channel 50, and an outlet 34 for evaporating the cell solution 60 introduced into the fluidic channel 50. When the polymer mold 30 is formed of PDMS, the inlet 32 and the outlet 34 may be formed by punching the polymer mold 30 with a hammer and an iron bar of a desired diameter.

That is, to inject the cell solution 60 into the fluidic channel and evaporate it, a connection path with the outside is necessary. In consideration of the structure of the analysis chip according to this embodiment, it is preferable that the connection path is formed on the polymer mold 30 that is disposed in an upper portion of the analysis chip 100.

Subsequently, referring to FIG. 6C, the substrate 10 with the polymer pattern layer 20 formed and the polymer mold 30 are plasma-treated. Through the plasma treatment, the polymer pattern layer 20 and the polymer mold 30 can be bonded to each other with ease. After the plasma treatment, the plasma-treated surface has hydrophilicity. Therefore, a surface tension acts on the cell solution 60 introduced into the fluidic channel 50 due to the hydrophilic properties, which facilitates a capillary flow. That is, such a reforming of the fluidic channel 50 by the plasma treatment allows the capillary flow caused by the surface tension to be facilitated.

Afterwards, referring to FIG. 6D, the substrate 10 having the plasma-treated polymer pattern layer 20 and the plasma-treated polymer mold 30 are boned to each other, thereby forming the fluidic channel 50.

Thereafter, to enhance a bonding force between the substrate 10 having the polymer pattern layer 20 and the polymer mold 30, the cell analysis chip may be thermally treated in a hot plate additionally.

Subsequently, according to the present invention, the cell solution 60 containing cells 62 is introduced into the fluidic channel 50.

Referring to FIG. 2, when the cell solution 60 containing the cells 62 is injected into the inlet 32 of the polymer mold 30, the cell solution 60 is introduced into the fluidic channel 50 by the capillary flow caused by the surface tension so that the fluidic channel 50 is filled with the cell solution 60. The surface tension increased by the plasma treatment illustrated in FIG. 6C results in an increase in hydrophilicity. Accordingly, the capillary flow can actively occur. Consequently, in this operation, the cell solution can be introduced into the microfluidic channel without an additional power or apparatus although very small volume of the cell solution 60 is used.

The cell solution 60 contains the cells 62 to be analyzed. The cell solution may contain yeast or animal cells. Here, it is preferable that a culture medium of corresponding cells is used as the solution. For example, to analyze yeast, the cell solution may use a solution where yeast cells are mixed in suspension state in a culture medium such as yeast extract peptone dextrose (YPD) medium.

To control a docking efficiency of the cells 62 with the well structure 22, the concentration of the cell solution 60 may be controlled using a centrifuge or the like. Preferably, the concentration of the cell solution 60 is in the range of approximately 1×10⁸ to approximately 1×10⁹ cells/ml based on an optical density of approximately 150-200 while considering economy and docking efficiency. Furthermore, the amount (volume) of the cell solution 60 to be used is determined in consideration of the volume of the fluidic channel 50. In general, it is appropriate that the volume of the cell solution 60 is equal to the volume of the fluidic channel 50 plus/minus approximately 1 μm.

Next, the cell solution 60 is manipulated in the fluidic channel 50 to array the cell 62 in the well structure 22.

Referring to FIG. 3, when the cell solution 60 is introduced and filled into the fluidic channel 50, and the outlet 34 is separately formed besides the inlet 32, the cell solution 60 may be evaporated due to natural convection. If the cell solution 60 is not supplied through the inlet 32 or a supplying rate of the cell solution 60 is lower than an evaporation rate, the volume of the cell solution is reduced.

Particularly, when the cell solution 60 is not supplied through the inlet 32, and only the outlet 34 is opened while sealing the inlet 32 with a tape or the like as illustrated in FIG. 3, the cell solution 34 recedes toward the inlet 32. Through such a manipulation of the cell solution, a receding meniscus RM having a concave boundary is formed, as shown in FIG. 3.

Referring to FIG. 4, when the receding meniscus RM recedes toward the inlet 32 gradually, a lateral capillary force acts on a thin region of the receding meniscus RM, so that the cells 62 dock with the well structures 22 and are arrayed. Herein, this phenomenon that the cells 62 dock with the well structures by the receding meniscus is called a receding meniscus induced docking (rMID).

If controlling the number and position of outlet, or controlling the inlet to be opened/closed, it is possible to control a receding direction. In addition, if controlling a size or depth of the well structure, the number of cells docking with one well structure can be controlled. That is, if controlling the size of the well structure, one cell may dock with and be arrayed in one well structure with very high docking efficiency (array at a single-cell level).

FIGS. 7 and 8 are optical microscope images showing that yeast cells are arrayed in rectangular well structures depending on the method of arraying cells at a single-cell level according to the embodiment of the present invention.

Referring to FIG. 7, it can be observed that yeast cells are arrayed in a number of microwells at a single-cell level due to a lateral capillary force at a thin region of a meniscus when a receding meniscus recedes.

Referring to FIG. 8, it can be observed that one to five cells dock(s) with each microwell.

Referring to FIG. 5, after the evaporation of the cell solution 60, residual cells, which cannot dock with the well structure 22, are clustered at a side of the inlet 32.

The present invention also provides a method of analyzing cells at a single-cell level using the above-described method of arraying the cells.

FIG. 9 is a flowchart illustrating a method of analyzing cells according to an embodiment of the present invention

Referring to FIG. 9, in operation S1, a cell analysis chip including a fluidic channel with a well structure is prepared first. In operation S3, a mixed solution, in which a cell solution having cells and an analysis reagent are mixed, is introduced into the fluidic channel. Afterwards, in operation S5, the mixed solution is manipulated in the fluidic channel to array the cells in the well structures. Subsequently, the response of the cells arrayed in the well structures upon the analysis reagent is analyzed, in operation S7.

The above-described operations S1, S3 and S5 are similar to the method of arraying cells, which has been described with reference to FIGS. 1 to 5. However, since the method of this embodiment is a method for analyzing specific behaviors of the cells, the mixed solution, in which the cell solution and the analysis reagent indicating a specific response of the cell are mixed, is introduced into the fluidic channel and then arrayed in the well structures.

For example, to obtain information with regard to a mating of the yeast cell, a pheromone, e.g., so-called α-factor, may be injected into the fluidic channel as the analysis reagent. If an a-type yeast cell is used as the cell, it is preferable that a pheromone of which a sequence is TRP-HIS-TRP-LEU-GLN-LEU-LYS-PRO-GLY-GLN-PRO-MET-TYR, is used as α-factor. In a subsequent operation, when analyzing responses, it is possible to obtain information with regard to whether or not a protein related to the mating is created in a corresponding cell, and the amount of the protein.

Further, if a salt, e.g., sodium chloride (NaCl) or potassium chloride (KCl), is used instead of the α-factor, and stress is applied to the corresponding yeast cell, it is possible to analyze how yeast responds to the external stress in a subsequent operation. Alternatively, the analysis reagent may be used in plurality to observe a plurality of characteristics of the cell.

Subsequently, in operation S7, an individual response of the cell arrayed in the well structure upon the analysis reagent, that is, a response at a single-cell level is analyzed. Here, the analysis method and its interpretation may vary depending on the used cell and analysis reagent.

For instance, in the case where the yeast cell is treated with α-factor, it is possible to observe whether or not a protein related to the mating is created and the amount of the protein through the expression intensity of a green fluorescent protein (GFP) with a time. Moreover, in the case where the yeast cell is treated with KCl, it is possible to find out the creation amount of corresponding proteins through a red fluorescent protein (RFP), and also analyze the response of the corresponding yeast cell upon the external stress.

Since the cell solution and the analysis reagent are injected into the fluidic channel at the same time, a process is very simple and it is unnecessary to perform a cleaning process of residual cells, which will be described later. Furthermore, the well structure may not be deepened because there is no possibility that the cell docking with the well structure is separated even though a cleaning solution is introduced into the fluidic channel.

FIG. 10 is a flowchart illustrating a method of analyzing cells according to another embodiment of the present invention.

Referring to FIG. 10, in operation S10, a cell analysis chip including a fluidic channel with a well structure is prepared. In operation S20, a cell solution having cells is introduced into the fluidic channel. Afterwards, in operation S30, the cell solution is manipulated in the fluidic channel to array the cells in the well structures. Subsequently, in operation S50, an analysis reagent is introduced into the fluidic channel. Then, the response of the cell arrayed in the well structure upon the analysis reagent is analyzed in operation S60.

The above-described operations S10, S20 and S30 are similar to the method of arraying cells, which has been described with reference to FIGS. 1 to 5. The operation S60 of analyzing the response of the cell upon the analysis reagent may be performed through the same method illustrated in operation S7 of FIG. 9. In this case, the analysis reagent may be used in plurality so as to observe various characteristics of the cell.

In this embodiment, only the cell solution is introduced first, and then the cells are arrayed in the well structure at a single-cell level. After that, in operation S40, the analysis reagent is introduced into the fluidic channel. The analysis reagent may also be introduced into the fluidic channel using a capillary flow due to a surface tension in the same manner as the introduction of the cell solution.

Before the analysis reagent is introduced (S50), a process of cleaning residual cells may be selectively performed in operation S40. FIG. 11 is a sectional view illustrating a cleaning process of residual cells, which may be performed during the method of analyzing cells according to the present invention.

Referring to FIG. 11, the residual cells not docking with the well structures remain at a side of the inlet after the cells are arrayed in the well structures. It is preferable that the analysis reagent is introduced (S50) after the residual cells are removed. Therefore, if the cleaning solution is injected into the fluidic channel through the inlet, and an absorbing medium such as a tissue paper, which can absorb this cleaning solution, is placed in the outlet, the residual cells are absorbed into the absorbing medium together with the cleaning solution and thus discharged through the outlet.

It is preferable that the cleaning solution uses a solution necessary for docking cells to survive. For example, in the case of yeast, it is preferable to use a synthetic complete (SC) medium containing amino acid, nitrogen, glucose, etc, which is necessary for the yeast to survive during observation.

In this embodiment, to prevent the docking cells from being swept away from the well structures during operation of injecting the analysis reagent or cleaning solution, it is preferable that the well structure is deeper than that of the previous embodiment where the analysis reagent is mixed with the cell solution and then the mixed solution is introduced into the fluidic channel. In addition, if the cell analysis is directed to observing a response of the cell upon the analysis reagent according to a time, the method of this embodiment is more available for a relatively accurate observation, compared to the previous embodiment where the analysis reagent is simultaneously injected with the cell solution.

That is, while the cell solution and the analysis reagent are mixed and introduced into the fluidic channel, and the cell docks with the well structure by the receding meniscus, a time may be delayed, which may cause a time-dependent analysis to be somewhat inaccurate. In this embodiment, however, the analysis reagent is separately introduced after the introduction of the cell solution, so that it is possible to more improve the accuracy for analysis. Further, in the previous embodiment, after the cells dock with the well structures by the receding meniscus, the evaporation continuously occurs inside the fluidic channel, which may cause the docking cells to be damaged. However, in this embodiment, it is possible to avoid such damage because the cleaning process is performed using the SC medium after the cells dock with the well structures. Consequently, this embodiment may be more effective in actual analysis than the previous embodiment.

According to the aforesaid analysis methods, since the microfluidic channel is used, only very small volume of the cell solution is required. Also, it is possible to observe a response of each cell economically, and to overcome an ensemble averaging problem and the like.

The present invention also provides a cell analysis chip used in realizing the method of arraying the cells at a single-cell level. FIG. 1 is a sectional view of an analysis chip 100 according to an embodiment of the present invention.

Referring again to FIG. 1, the analysis chip of this embodiment includes a substrate 10, a polymer pattern layer 20 with well structures 22 disposed on the substrate 10, and a polymer mold 30 disposed on the polymer pattern layer 20 to form a fluidic channel 50. Such an analysis chip 100 may be fabricated using the method described with reference to FIG. 6. In the case of analyzing cells using this analysis chip 100, it is preferable that an inlet 32 and an outlet 34 for the cell solution are provided. For example, it is preferable that the inlet 32 and the outlet 34 are formed on the polymer mold 30.

FIG. 12 is a photograph showing a cell analysis chip that is actually fabricated according to the present invention. The cell analysis chip of FIG. 12 is portable so that the cell analysis is not necessarily carried out only in a laboratory, resulting in an increase in use efficiency. Moreover, the analysis chip of this embodiment is advantageous in that the cells can be arrayed at a single level without an additional apparatus by only dropping the cell solution into the inlet, which allows the cells to be analyzed at a single level.

[Advantageous Effects]

According to the present invention, since cells are arrayed using a receding meniscus and a capillary flow caused by a surface tension, it is possible to array the cells at a single-cell level very simply and economically without an additional apparatus or power.

Furthermore, the present invention is applicable to a large scale using only very small amount of sample so that a large amount of cell can be rapidly and uniformly arrayed in each well structure at a single-cell level and can be used for a single cell analysis.

Therefore, the responsiveness, e.g., response intensity of each cell, not a cell group, upon an analysis reagent can be individually observed and analyzed, thus overcoming an ensemble averaging problem. That is, it is possible to observe the response at an individual cell level more accurately. In particular, the arraying method according to the present invention is advantageous in that it can be applied to an animal cell as well as a suspended cell such as yeast.

Since the analysis chip using this arraying method can be very simply constructed and used easily, this chip is portable so that an analysis place is not limited to a laboratory only and a response of an individual cell can be economically observed as well.

In conclusion, the methods and the analysis chip of the present invention may be used as a platform technology widely applicable to bio industries, which can enhance the reliability of a cell analysis and improve the efficiency and accuracy of an individual cell analysis notably.

It will be apparent to those skilled in the art that various modifications and variations can be made in the present invention. Thus, it is intended that the present invention covers the modifications and variations of this invention provided they come within the scope of the appended claims and their equivalents.

### DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1 to 5 are sectional views illustrating a method of arraying cells at a single-cell level according to an embodiment of the present invention;

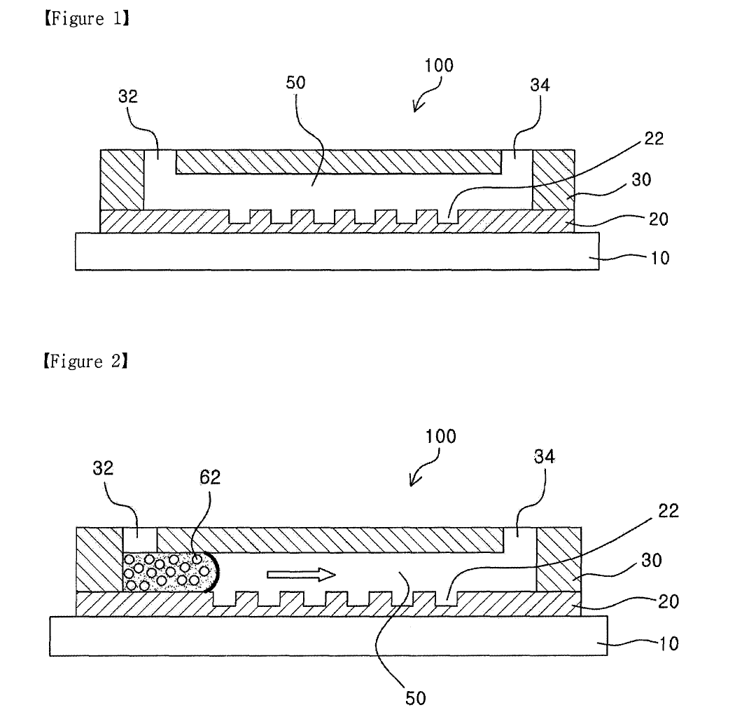

FIGS. 6A to 6D are sectional views illustrating a method of forming a cell analysis chip shown in FIG. 1;

FIGS. 7 and 8 are optical microscope images showing that yeast cells are arrayed in rectangular well structures depending on the method of arraying the cells at the single-cell level according to the embodiment of the present invention;

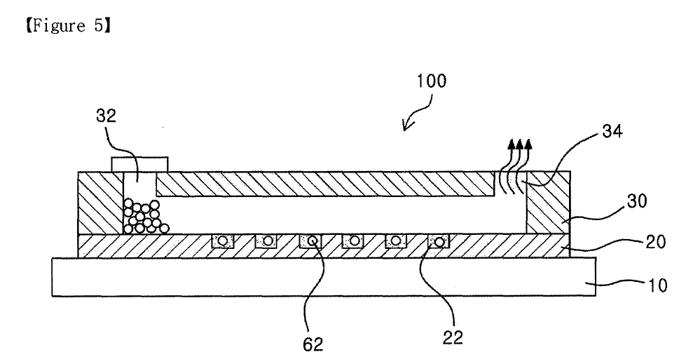

FIG. 9 is a flowchart illustrating a method of analyzing cells according to an embodiment of the present invention;

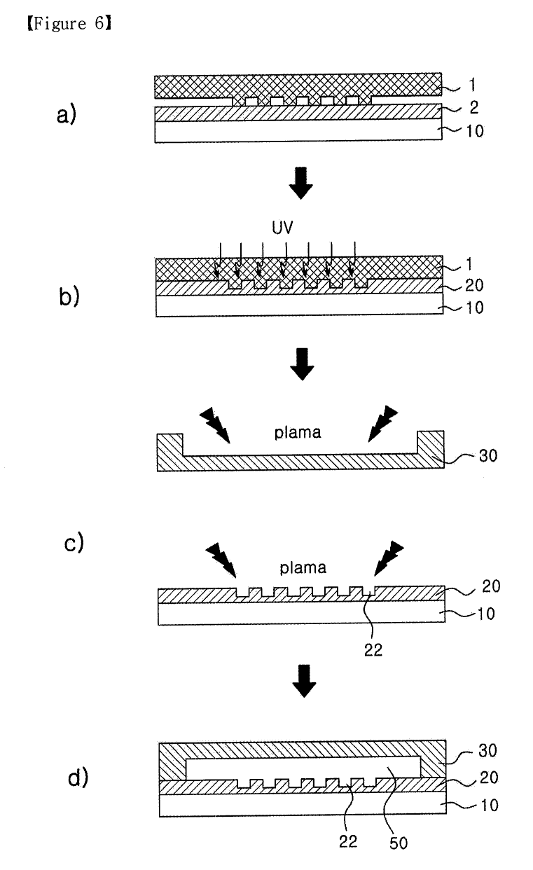

FIG. 10 is a flowchart illustrating a method of analyzing cells according to another embodiment of the present invention;

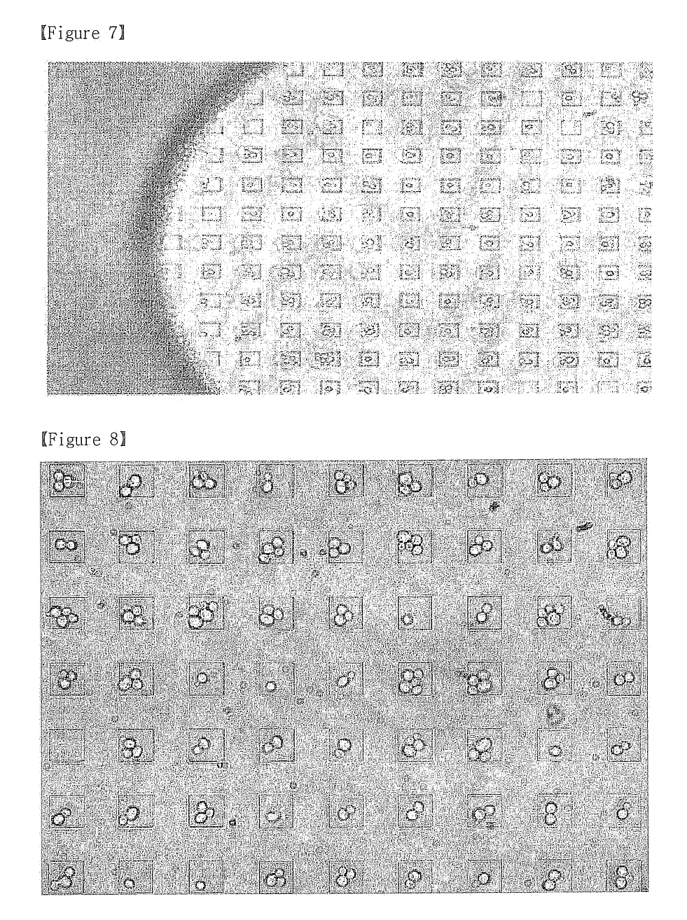

FIG. 11 is a sectional view illustrating a cleaning process of residual cells, which may be performed during the method of analyzing cells according to the present invention;

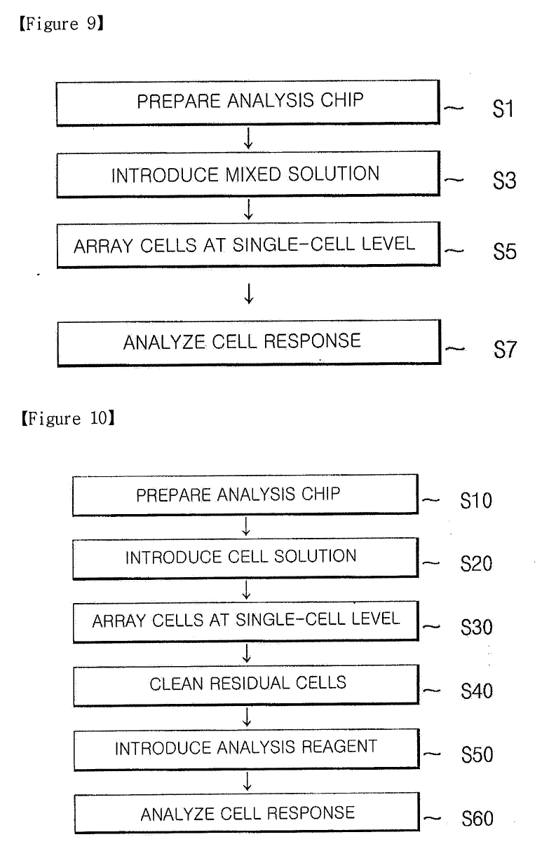

FIG. 12 is a photograph showing a cell analysis chip that is actually fabricated according to the present invention;

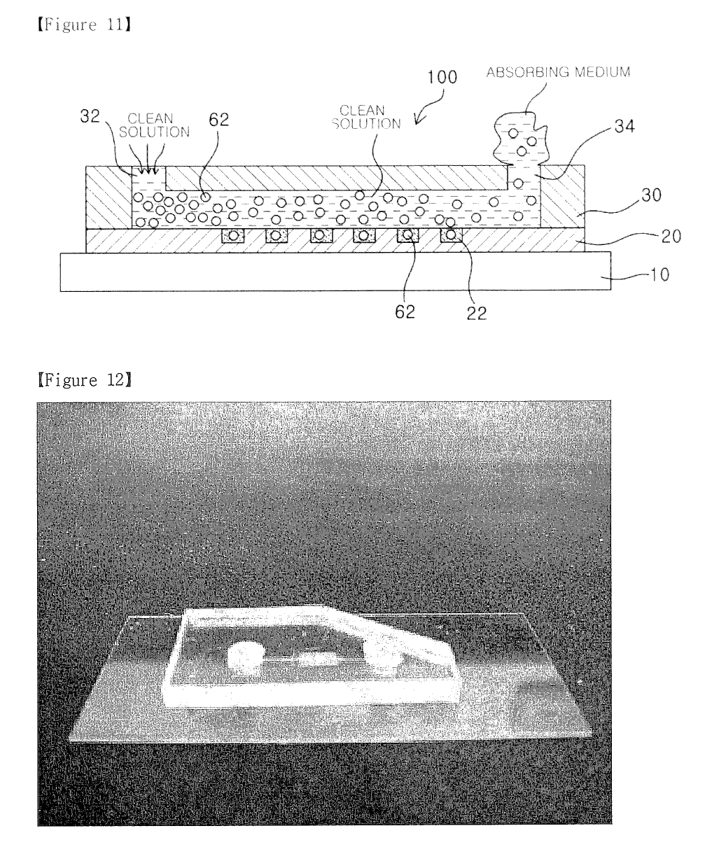

FIGS. 13A and 13B are scanning electron microscope (SEM) images of rectangular microwell structures formed according to the embodiments 1 and 2;

FIG. 14 is a micrograph showing GFP expression of a yeast cell of the embodiment 1 with respect to α-factor according as a time elapses;

FIG. 15 is a micrograph showing GFP expression of a yeast cell of the embodiment 2 with respect to α-factor according as a time elapses;

FIG. 16 is a SEM image showing a circular microwell formed through a method of arraying cells at a single-cell level according to the embodiment 3;

FIG. 17 is an optical microscope image showing that yeast cells are arrayed in circular microwells according to the embodiment 3; and

FIGS. 18A to 18C are fluorescent images showing GFP and RFP expressions of yeast cells according to the embodiment 3.

### BEST MODE

Reference will now be made in detail to the preferred embodiments of the present invention, examples of which are illustrated in the accompanying drawings. However, the present invention is not limited to the embodiments illustrated hereinafter, and the embodiments herein are rather introduced to provide easy and complete understanding of the scope and spirit of the present invention.

### Embodiment 1

Shallow Rectangular Well Structure

1) Preparation of Cell Analysis Chip

A PDMS pre-polymer and a curing agent were mixed at a ratio of 10:1, and then the mixture was poured onto an intagliated silicon wafer that had been prepared through photolithography. Thereafter, the wafer with the mixture were cured at 70° C. for 1 hour in an oven, thereby fabricating a PDMS embossed stamp.

Subsequently, a PUA polymer pattern layer having a micro-sized PUA well structure (PUA microwell structure) was formed through a capillary lithography. Specifically, a few of PUA polymer droplets were dropped onto a glass substrate, and the prepared PDMS embossed stamp was then disposed. The PUA polymer was filled into a vacant space of the polymer embossed stamp 1 by capillary flow. Under this condition, the PUA polymer was cured using UV ray.

Thereafter, the PDMS embossed stamp was detached from the glass substrate to thereby form a polymer pattern layer having an opposite shape to the PDMS embossed stamp. Herein, the polymer pattern layer had PUA microwell structures each having a rectangular shape of 10 μm×10 μm and a depth of 1 μm.

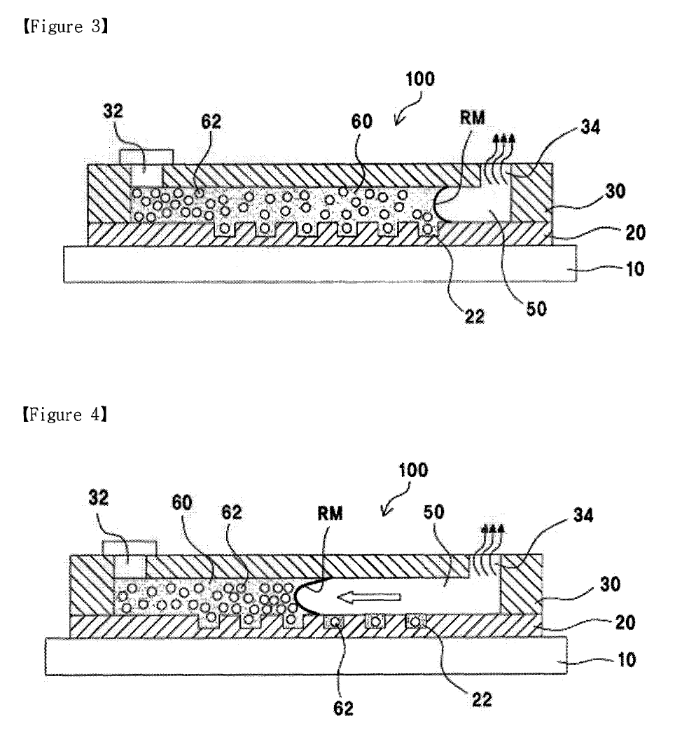

Afterwards, the glass substrate having the PUA well structures and the PDMS channel mold were plasma-treated (see FIG. 6) and then bonded to each other, thereby forming a PDMS microfluidic channel where the PUA microwell structures were formed.

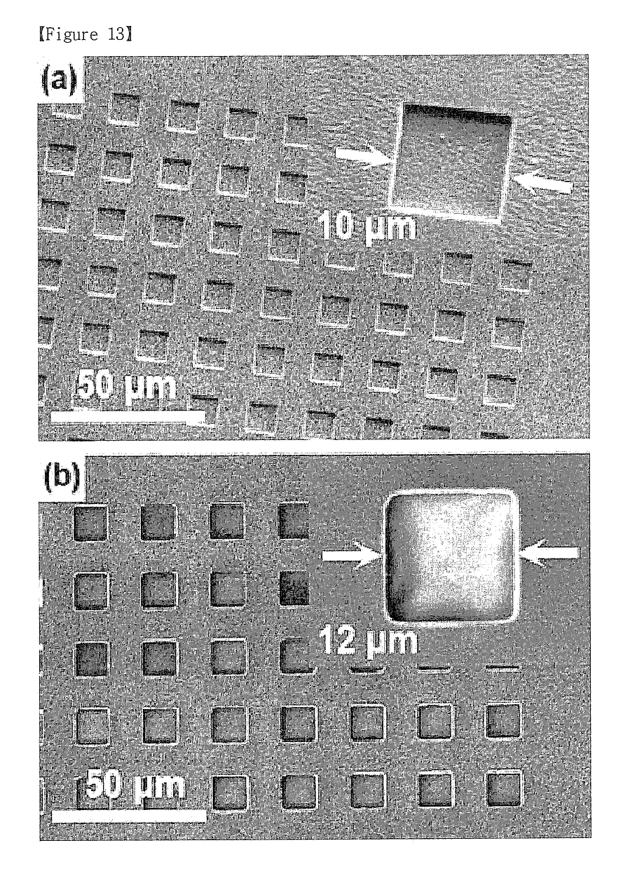

FIG. 13A is a scanning electron microscope (SEM) image showing a well structure formed by the above-described method. As illustrated in FIG. 13A, the PUA microwell structure formed by capillary lithography has such advantageous merits that its shapes are uniform and it is robust. The PUA microwell structure had a size of 10 μm×10 μm and a depth of 1 μm. It could be observed that the well structure had an integration degree of 2,500 wells/mm². A square image in the right and upper side of FIG. 13A is an enlarged image of one well structure.

2) Introduction of Mixed Solution and Cell Array at Single-Cell Level

A mixed solution in which a-type yeast cell solution using yeast extract peptone dextrose (YPD) medium had been pre-treated with α-factor, e.g., pheromone having a sequence of TRP-HIS-TRP-LEU-GLN-LEU-LYS-PRO-GLY-GLN-PRO-MET-TYR, was introduced into a fluidic channel through an inlet. The introduced mixed solution filled the fluidic channel through a capillary flow.

After that, the inlet was sealed with a tape so that the mixed solution was evaporated through an outlet. Accordingly, a receding meniscus was generated, allowing the cells to be arrayed in the well structures at a single-cell level. At this time, it took about 10 minutes for the cells to be arrayed while the meniscus was receding.

3) Fluorescent Analysis of Cell

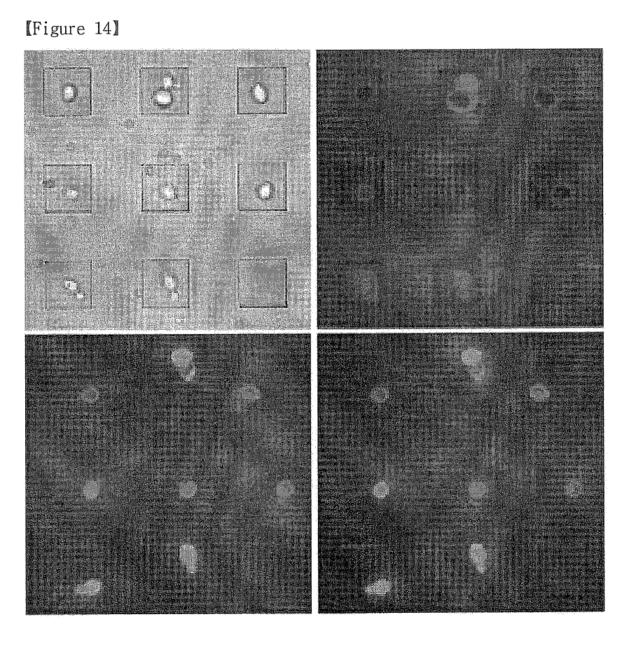

FIG. 14 is a micrograph showing GFP expression of a yeast cell with respect to α-factor according as a time elapses using the fluidic channel. Specifically, in a clockwise direction from the micrograph in the left and upper side of FIG. 14, four micrographs respectively show GFP expressions at 0, 30, 60 and 120 minutes after the α-factor treatment.

Referring to FIG. 14, the GFP expression cannot be observed yet at 30 minutes after the CL-treatment (see the micrograph in the right and upper side), but the GFP expression is observed to be bright at 60 minutes after the α-treatment (see the micrograph in the right and lower side). Also, it can be observed that the GFP expression intensity does not vary even at 120 minutes after cl-treatment.

### Embodiment 2

Deep Rectangular Well Structure

1) Preparation of Cell Analysis Chip

A cell analysis chip was prepared through the same method of the embodiment 1 except that the PUA microwell structure has a size of 12 μm×12 μm and a depth of 12 μm. Why the depth of the microwell becomes greater than that of the embodiment 1 is to prevent the docking cells from being swept away from the microwell structures during a cleaning process.

Thereafter, the glass substrate having the PUA well structures and the PDMS channel mold were plasma-treated and then bonded to each other, thereby forming a PDMS microfluidic channel where the PUA microwell structures were formed. It could be observed that the well structure had an integration degree of 1,736 wells/mm².

FIG. 13B is a SEM image showing a well structure formed by the above-described method. A square image in the right and upper side of FIG. 13B is an enlarged image of one well structure.

2) Introduction of Cell Solution and Cell Array at Single-Cell Level

An a-type yeast cell solution using YPD medium was introduced into a fluidic channel. The introduced cell solution was filled into the fluidic channel through a capillary flow. After that, the inlet was sealed with a tape so that the cell solution was evaporated through an outlet. Accordingly, a receding meniscus was generated, thereby allowing the cells to be arrayed in the well structures at a single-cell level.

3) Cleaning

Afterwards, a cleaning solution containing amino acid, nitrogen, glucose, etc was introduced through the capillary flow caused by a surface tension, residual cells remaining at a side of the inlet were cleaned. At this time, a tissue paper was placed in the outlet to absorb and remove the residual cells and the cleaning solution.

4) Introduction of Analysis Reagent

After the residual cells are completely cleaned, CL-factor was also introduced into the microfluidic channel by the capillary flow caused by the surface tension. To prevent the CL-factor introduced into the channel from being evaporated, the inlet and the outlet of the microfluidic channel were sealed using a tape.

5) Fluorescent Analysis of Cell

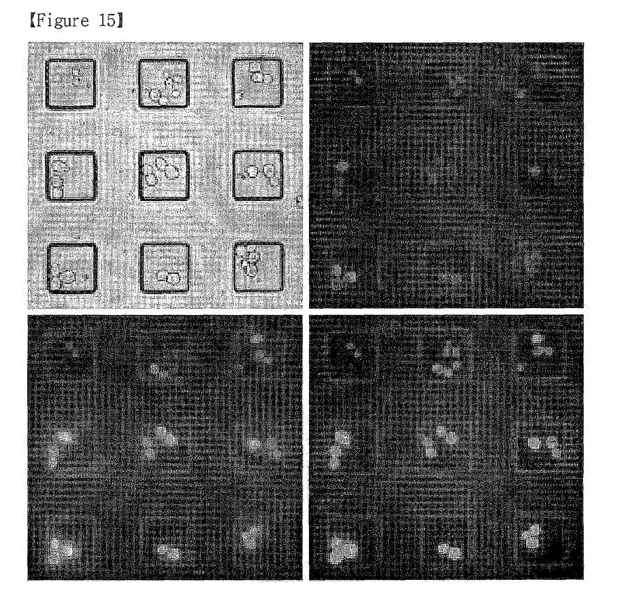

FIG. 15 is a micrograph showing GFP expression of a yeast cell with respect to α-factor according as a time elapses using the fluidic channel. Specifically, in a clockwise direction from the micrograph in the left and upper side of FIG. 15, four micrographs respectively show GFP expressions at 0, 30, 60 and 120 minutes after the CL-factor treatment.

Referring to FIG. 15, the GFP expression cannot be observed yet at 30 minutes after the α-treatment (see the micrograph in the right and upper side), the GFP expression is observed to be bright at 60 minutes after the α-treatment (see the micrograph in the right and lower side). Also, it can be observed that the GFP expression intensity does not vary even at 120 minutes after CL-treatment.

### Embodiment 3

Circular Well Structure

1) Preparation of Cell Analysis Chip

A cell analysis chip was prepared through the same method of the embodiment 2 except that the PUA microwell structure has a circular shape with a diameter of 8 μm and a depth of 8 μm. Why the call analysis chip of this embodiment differs in shape and size from that of the embodiment 2 is to enhance docking efficiency, that is, to array only one cell in each well structure if possible.

Thereafter, the glass substrate having the PUA well structures and the PDMS channel mold were plasma-treated and then bonded to each other, thereby forming a PDMS microfluidic channel where the PUA microwell structures were formed. It could be observed that the well structure had an integration degree of 3906.25 wells/mm².

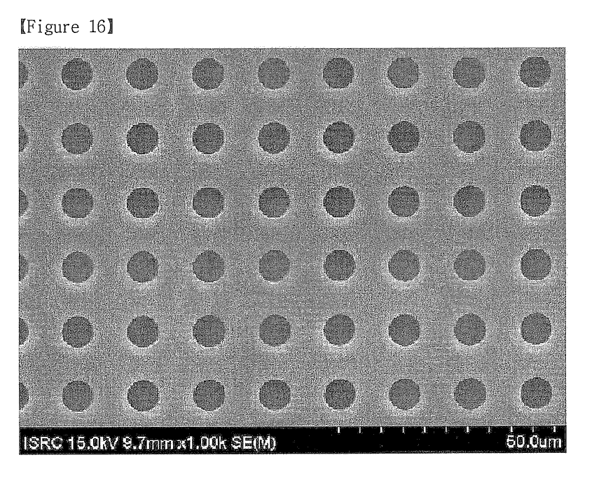

FIG. 16 is a SEM image of the PUA circular microwell structure formed through the above-described method,

2) Introduction of Cell Solution and Cell Array at Single-Cell Level

An a-type yeast cell solution using YPD medium was introduced into a fluidic channel. The introduced cell solution was filled into the fluidic channel through the capillary flow. After that, the inlet was sealed with a tape so that the cell solution was evaporated through an outlet. Accordingly, a receding meniscus was generated, thereby allowing the cells to be arrayed in the well structures at a single-cell level. In this embodiment, the yeast cell is tagged with both GFP and RFP.

3) Cleaning

Afterwards, a cleaning solution containing amino acid, nitrogen, glucose, etc was introduced through the capillary flow caused by the surface tension, and residual cells remaining at a side of the inlet were cleaned. At this time, a tissue paper was placed in the outlet to absorb and remove the residual cells and the cleaning solution.

After the residual cells are completely cleaned, an SC medium was also introduced into the microfluidic channel by the capillary flow caused by the surface tension. To prevent the SC medium introduced into the channel from being evaporated, the inlet and the outlet of the microfluidic channel were sealed using a tape.

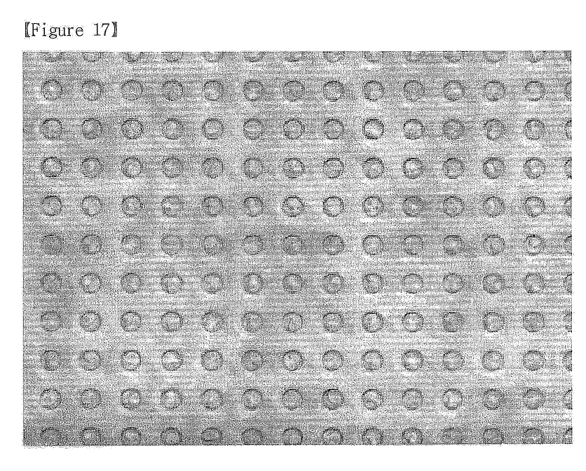

FIG. 17 is an optical microscope image showing that yeast cells are arrayed in circular well structures according to this embodiment. The reason this circular well structure with small size is used instead of the rectangular well structure is that the circuit well structure can improve the array efficiency by docking at a single-cell level. From FIG. 17, it can be observed that an array efficiency at a single-cell level is more improved in comparison with that of the rectangular well structure.

4) Fluorescent Analysis of Cell

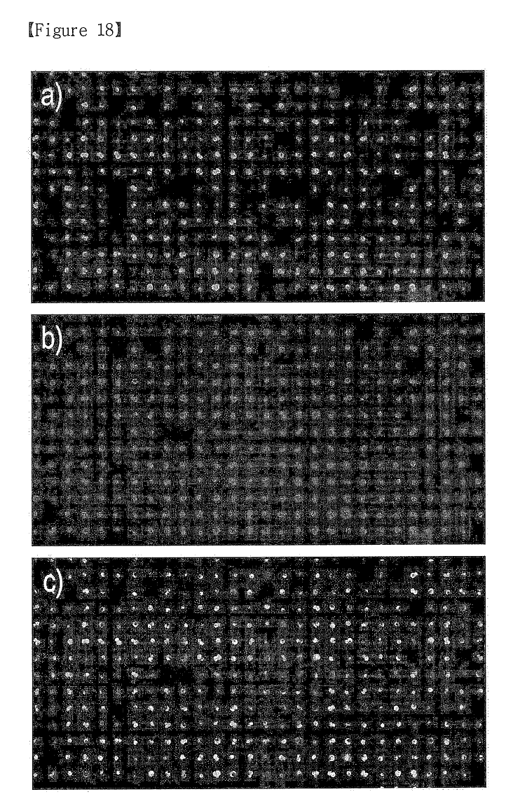

FIGS. 18A to 18C are fluorescent images showing GFP and RFP expressions of yeast cells using the fluidic channel. In detail, FIG. 18A shows GFP expression, FIG. 18B shows RFP expression, and FIG. 18C shows an overlap image of the GFP and RFP expression images.

Referring to FIG. 18A, it can be observed that GFP expression intensity is different in every cell. This proves that cells can be individually analyzed at a single-cell level, not at a group level because of using the inventive method of arraying the cells at a single-cell level.

Referring to FIG. 18B, it can be observed that RFP expression also is different in every cell.

Referring to FIG. 18C, it can be observed that there are various colors from green to red because the expression intensity is different in every cell when the GFP and RFP expression images overlap each other.

According to the foregoing embodiments 1 to 3, it is possible to array cells at a single-cell level. Therefore, GFP response to α-factor according to a time and an RFP response to salt stress can also be observed individually in every cell.

1. A method of arraying cells at a single-cell level in a fluidic channel, the method comprising:
preparing a cell analysis chip including a fluidic channel having well structures;
introducing a cell solution containing cells into the fluidic channel; and
manipulating the cell solution in the fluidic channel to array the cells in the well structures.

2. The method of claim 1, wherein the preparing of the cell analysis chip comprises:
forming a polymer pattern layer on a substrate, the polymer pattern layer comprising well structures formed by a capillary lithography;
preparing a polymer mold to be bonded to the polymer pattern layer to form a fluidic channel;
performing a plasma treatment on the polymer mold and the substrate with the polymer pattern layer formed; and
bonding the plasma-treated polymer mold to the substrate with the plasma-treated polymer pattern layer to form the fluidic channel.

3. The method of claim 2, wherein the polymer pattern layer comprises polyurethaneacrylate (PUA), and the polymer mold comprises polymethylsiloxane (PDMS).

4. The method of claim 2, further comprising, after the forming of the fluidic channel, thermally treating the fluidic channel in a hot plate to enhance a bonding force between the polymer mold and the substrate with the polymer pattern layer.

5. The method of claim 2, wherein the preparing of the polymer mold comprises:
forming an inlet for introducing the cell solution into the fluidic channel; and
forming an outlet for evaporating the cell solution introduced into the fluidic channel.

6. The method of claim 1, wherein the introducing of the cell solution comprises introducing the cell solution into the fluidic channel by a capillary flow caused by a surface tension.

7. The method of claim 1, wherein the manipulating of the cell solution in the fluidic channel to array the cells in the well structures is performed in such a way that the cells dock with and are arrayed in the well structures by a receding meniscus formed while the cell solution recedes according to the evaporation of the cell solution.

8. The method of claim 7, wherein, while the inlet is sealed, the cell solution recedes to fix a receding direction of the cell solution.

9. The method of claim 1, wherein a shape, size and depth of the well structure are adjusted depending on number and a kind of the cell.

10. The method of claim 1, wherein the cell solution comprises a solution containing yeast cells or animal cells.

11. A method of analyzing cells at a single-cell level, the method comprising:
preparing a cell analysis chip including a fluidic channel having well structures;
introducing a mixed solution into the fluidic channel, the mixed solution including a cell solution containing cells and an analysis reagent;
manipulating the cell solution in the fluidic channel to array the cells in the well structures; and
analyzing a response of the cell arrayed in the well structure upon the analysis reagent.

12. A method of analyzing cells at a single-cell level, the method comprising:
preparing a cell analysis chip including a fluidic channel having well structures;
introducing a cell solution containing cells into the fluidic channel;
manipulating the cell solution in the fluidic channel to array the cells in the well structures;
introducing an analysis reagent into the fluidic channel; and
analyzing a response of the cell arrayed in the well structure upon the analysis reagent.

13. The method of claim 12, further comprising, after the arraying of the cells in the well structures, performing a cleaning process to remove residual cells in the cell solution introduced into the fluidic channel except for the cells arrayed in the well structures.

14. The method of claim 12, the introducing of the analysis reagent is performed using a plurality of analysis reagents to observe a plurality of cell characteristics.

15. A cell analysis chip of a single-cell level, comprising:
a substrate;
a polymer pattern layer disposed on the substrate, and including well structures for arraying cells at a single-cell level; and
a polymer mold disposed on the polymer pattern layer to form a fluidic channel.

16. The cell analysis chip of claim 15, further comprising an inlet and an outlet disposed on the polymer mold.
